(19) United States
(12) Patent Application Publication
(10) Pub. No.: US 2016/0205889 A1
(43) Pub. Date: Jul. 21, 2016

(54) PET URINAL PAD HAVING DETECTION FUNCTION

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 14/950,958

(22) Filed: Nov. 24, 2015

(30) Foreign Application Priority Data
Jan. 16, 2015 (CN) 201520033287.8

(51) Int. Cl. A01K 1/01

(52) U.S. Cl. CPC A01K 1/0107

(57) ABSTRACT

A pet urinal pad having a detection function, wherein a urinal pad body of the pet urinal pad has a stratiform structure includes: a non-woven fabric coating layer on top, a PE film leakage prevention layer at bottom, an absorbing layer arranged between the non-woven fabric coating layer and the PE film leakage prevention layer; and a toilet paper absorbing layer arranged between the PE film leakage prevention layer and the absorbing layer, wherein a plurality of detection regions embedded with different functional color-development agents are arranged between the non-woven fabric coating layer and the absorbing layer, wherein the plurality of detection regions are arranged in different shapes.

### CROSS-REFERENCE TO RELATED APPLICATIONS

This Application claims priority of Chinese Patent Application No. 201520033287.8, filed on Jan. 16, 2015, the disclosure of which is incorporated by reference in its entirety.

### TECHNICAL FIELD

The invention relates to a pet urinal pad, and more particularly, to a pet urinal pad having detection function, which belongs to the technical field of pet products.

### BACKGROUND OF INVENTION

Currently, with the improvement in people's living standards, pets like cats, dogs or the like have entered the lives of people, playing an increasingly important role. People are also demanding more for the sanitation of the pets. However, in daily life, it is very troublesome to dispose of pet excreta, which requires the pet masters to pay much attention. To protect environments and also create a more comfortable habitat for the pets, to meet the animal right demands of the pets, and meanwhile to reduce the tedious work of people for sweeping the pets, quite a number of people have use pet urinal pads while keeping pets.

Existing pet urinal pads generally only have the functions of absorbing pet urines. Whether a pet is sick or diabetic or not, it is necessary to collect urines specifically for the tests. This is not timely and is also very cumbersome.

Chinese patent application publication No. 103999782A discloses a production technology for the production of pet urinal pads having disease detection functions. These pads include urine detection regions that are formed by attaching the urine color developing agents, under the action of ethanol and ion exchange resins, to wood pulp. Although these pads have the urine detection functions, these urinal pads still have disadvantages that: (1) the steps are tedious and the production technology is complicated; (2) only one urine index can be detected; and (3) the color displayed is simple, and the user cannot obtain direct information.

Chinese patent application publication No. of 2038014510 discloses a multifunctional pet urinal pads, which realize detection functions by incoproating test papers in the urinal pads. However, these urinal pads still have multiple defects: (1) although multiple body fluid indexes may be detected simultaneously, the area of the test paper is too small, which is not apparent to use; and (2) the color displayed is simple, and the user cannot obtain direct information.

### SUMMARY OF INVENTION

An object of the invention is to provide pet urinal pads having body fluid detection functions so as to solve the foregoing problems of the prior art.

To solve the foregoing technical problem, embodiments of the invention employ a technical scheme as follows:

A pet urinal pad having a detection function, wherein a body of the urinal pad is a stratiform structure, which includes: a non-woven fabric coating layer on the top side and a PE film leakage prevention layer on the bottom side, wherein an absorbing layer is arranged between the coating layer and the PE film leakage prevention layer; a toilet paper absorbing layer is arranged between the leakage prevention layer and the absorbing layer; a plurality of detection regions splashed (sprayed or coated) with different functional color development powders are arranged between the coating layer and the absorbing layer, wherein the detection regions are set into different shapes.

The shapes of the powder detection regions may be signs, English letters or Chinese characters. For example, a urine glucose detection region may be shaped as “GLU” (the abbreviation of urine glucose).

The outer edge of the absorbing layer and the outer edge of the toilet paper absorbing layer overlap (stack).

For better absorption, a plurality of absorption holes may be uniformly arranged on the coating layer at locations corresponding to (above) the position of the absorbing layer.

Embodiments of the invention have the following advantageous effects: (1) the detection functions may be divided into a plurality of regions by splashing powder color developing agents between the coating layer and the absorbing layer of the urinal pad body; and (2) various shapes may be splashed so that it is clear for the user to see. Embodiments of the invention may be difficult to implement using a conventional liquid manufacturing technique.

### BRIEF DESCRIPTION OF DRAWINGS

FIG. 1 shows a diagram illustrating a top structure of an embodiment of the invention.

In the figure: 1 refers to a urinal pad body, and 2 refers to a detection region.

### DETAILED DESCRIPTION

The technical characteristics of the invention will be described in details hereinafter with references to the drawings and examples.

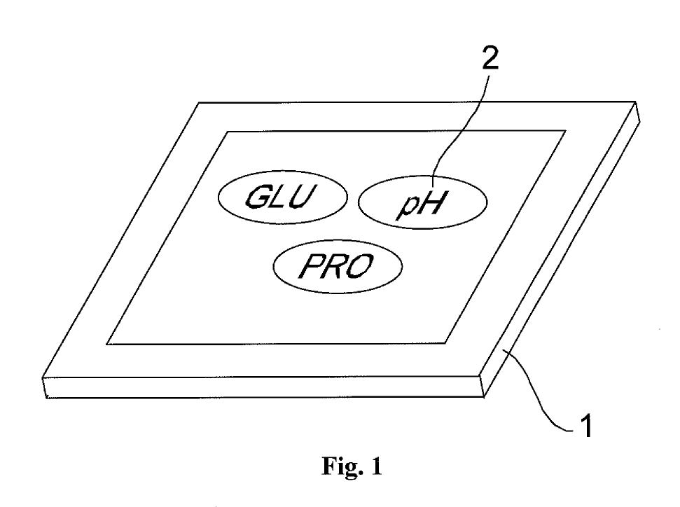

A pet urinal pad having a detection function is illustrated in FIG. 1, wherein a urinal pad body 1 has a stratiform (layered) structure, which includes: a non-woven fabric coating layer on the top side and a PE film leakage prevention layer on the bottom side, wherein an absorbing layer is arranged between the coating layer and the PE film leakage prevention layer; a toilet paper absorbing layer is arranged between the leakage prevention layer and the absorbing layer; a plurality of detection regions 2 splashed (sprayed or embedded) with different functional color-development agents (i.e., color-developing powders, paste, etc.) are arranged between the coating layer and the absorbing layer, wherein the detection regions 2 may be set into different shapes.

The different functional color-developing agents may be for detecting different diseases or conditions. The various functions of the detections regions may be used to analyze urines for conditions similar to those routinely performed for urine analysis, such as testing for the presence of proteins, glucose, ketones, hemoglobin, bilirubin, urobilinogen, acetone, nitrite, leucocytes, pH values and infections by different pathogens.

The shapes of the powder detection regions may be signs, English letters or Chinese characters. For example, a urine glucose detection region may be shaped as “GLU” (the abbreviation of urine glucose). The different shapes of such regions can provide direct information to the user without having the users to know or memorize which detection regions are for what conditions.

The outer edge of the absorbing layer and the outer edge of the toilet paper absorbing layer overlap (stack on tope of each other).

In accordance with embodiments of the invention, an absorbing layer may be formed by mixing wood pulp, PP fiber and fast absorption super absorbent molecules.

For better absorption, a plurality of absorption holes may be uniformly arranged in the coating layer at locations corresponding to (above) the absorbing layer.

During use, the urine infiltrates below the coating layer and is contacted with the detection regions, and a powder color developing agent of the detection region reacts with the urine to exhibit different colors and/or shapes. Therefore, the user can clearly see the body conditions of the pets.

What is claimed is:

1. A pet urinal pad having a detection function, wherein a urinal pad body of the pet urinal pad has a stratiform structure comprising:
a non-woven fabric coating layer on top,
a PE film leakage prevention layer at bottom,
an absorbing layer arranged between the non-woven fabric coating layer and the PE film leakage prevention layer; and
a toilet paper absorbing layer arranged between the PE film leakage prevention layer and the absorbing layer,
wherein a plurality of detection regions embedded with different functional color-development agents are arranged between the non-woven fabric coating layer and the absorbing layer,
wherein the plurality of detection regions are arranged in different shapes.

2. The pet urinal pad having a detection function according to claim 1, wherein the different shapes of the plurality of detection regions comprise signs, English letters, or Chinese characters.

3. The pet urinal pad having a detection function according to claim 1, wherein an outer edge of the absorbing layer and an outer edge of the toilet paper absorbing layer overlap.

4. The pet urinal pad having a detection function according to claim 1, wherein a plurality of absorption holes are arranged in the coating layer.

5. The pet urinal pad having a detection function according to claim 1, wherein the plurality of detection regions are for detecting different conditions.
